(19) United States
(12) Patent Application Publication
(10) Pub. No.: US 2026/0178349 A1
(43) Pub. Date: Jun. 25, 2026

(54) ORGANIZING COLLABORATIVE DATA PROCESSING SYSTEMS

(71) Applicant: Dell Products L.P., Round Rock, TX (US)

(72) Inventors: ASHOK NARAYANAN POTTI, BANGALORE (IN); TSEHSIN JASON LIU, WELLESLEY, MA (US); ZIJIA WANG, LONDON (GB); DALE WANG, HAYWARD, CA (US); MIN GONG, SHANGHAI (CN)

(21) Appl. No.: 18/990,051

(22) Filed: Dec. 20, 2024

(51) Int. Cl. G06F 9/448

(52) U.S. Cl. CPC G06F 9/4482

(57) ABSTRACT

Methods and systems for managing operation of a deployment comprising data processing systems are disclosed. The operation may be managed by organizing a group of at least two data processing systems for performance of the operation. The group may be organized by a first data processing system. The first data processing system may assess an impact of the operation. The impact of the operation may be used with an autonomy model of the first data processing system to determine a level of autonomy of the first data processing system. Using the level of the autonomy and/or a similarity map of data processing systems, the first data processing system may select at least one other data processing system with which to collaborate for performance of the operation.

### FIELD

Embodiments disclosed herein relate generally to managing operation of a deployment comprising data processing systems. More particularly, embodiments disclosed herein relate to organizing a group of at least two data processing systems for performance of the operation.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIGS. 2D-2E show interaction diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment comprising data processing systems. The operation may be managed by organizing a group of at least two data processing systems to collaboratively perform the operation. The group may be organized by identifying, by a first data processing system, the operation. An impact level of the operation on a system may be determined by the first data processing system using at least one impact model.

Based on the impact level, a level of autonomy for a manner in which to perform the operation may be identified by at least one autonomy model of the data processing system. The level of the autonomy may include a measure of discretion ascribed to the first data processing system in performance of the operation. Using the level of the autonomy and/or a similarity map of data processing systems of a deployment, at least one other data processing system may be selected by the first data processing system. A similarity map may include at least one ranking of similarity between the first data processing system and/or the at least one other data processing system.

Upon selecting, by the first data processing system, the at least one other data processing system, the first data processing system and/or the at least one other data processing system may collaborate with the one other data processing system to (i) choose a manner in which to perform the operation and/or (ii) perform the operation in the manner that was chosen.

In an embodiment, a method for managing operation of a deployment comprising data processing systems is disclosed. The method may include: (i) obtaining, by a data processing system of the data processing system, a forthcoming operation, the forthcoming operation being performable in at least two manners, (ii) obtaining, by the data processing system, an estimated impact level of the forthcoming operation on the deployment, (iii) identifying, by the data processing system, a level of autonomy for selection of a manner in which to perform the forthcoming operation based on the estimated impact level, (iv) identifying, by the data processing system, at least one of the data processing systems based on a similarity map and the level of the autonomy, (v) collaboratively selecting, by the data processing system with the at least one of the data processing systems, the manner in which to perform the forthcoming operation, and (vi) performing, at least in part by the data processing system, the forthcoming operation in accordance with the selected manner of the forthcoming operation.

The similarity map may quantify levels of similarity between the data processing systems.

The level of similarity may be based on, for the data processing system (i) device information, (ii) network information, (iii) configuration information, and (iv) workload information.

The device information may include (i) a chassis identification, (ii) a port identification, (iii) a port description, (iv) a system name, (v) a system description, and (vi) capabilities of the data processing system.

The network information may include (i) a virtual local area network of which the data processing system is a member, (ii) a media access control address assigned to the data processing system, and (iii) link information between the data processing system and others of the data processing systems.

The configuration information may include (i) central processing unit specifications, (ii) a memory capacity, (iii) a storage capacity, and (iv) software specifications.

The workload information may include (i) an average central processing unit utilization, (ii) a maximum central processing unit utilization, (iii) a minimum central processing unit utilization, (iv) an average memory utilization, and (v) application running schedules.

Performing the forthcoming operation may include (i) decomposing the forthcoming operation into sub-operations and (ii) assigning at least a portion of the sub-operations for completion by others of the data processing systems.

Selecting the manner in which to perform the forthcoming operation may include querying the at least one of the data processing systems regarding the manner to come to a collaborative decision regarding the manner in which to perform the forthcoming operation.

The collaborative decision may include a most common response to the querying of the at least one of the data processing systems.

The level of autonomy may be identified using an autonomy model that vests more decision power in the data processing system as the level of impact is reduced and vests less decision power in the data processing system as the level of impact is increased.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

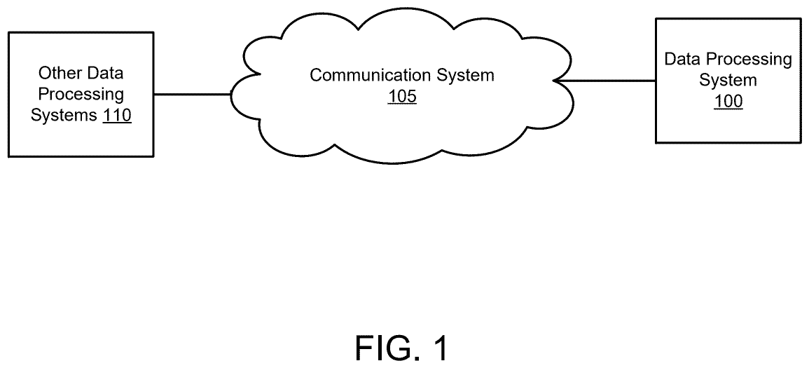

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a data processing system may perform an operation. The data processing system may perform the operation by performing at least one task of the operation. The data processing system may perform the operation autonomously without guidance of a management system.

However, if the data processing system operates without autonomously determining the at least one task, then the data processing system may behave in an unpredictable manner. If the data processing system behaves in an unpredictable manner, then a provision of the computer implemented services may be impacted.

In general, embodiments disclosed here relate to systems and methods for managing operation of a deployment comprising data processing systems. The operation may be managed by performing, by a data processing system of a deployment, a forthcoming operation without guidance of a management system.

To perform the forthcoming operation, the forthcoming operation may be obtained. The forthcoming operation may be obtained by (i) reading a configuration of the data processing system, (ii) ingesting an input by a user into the data processing system, (iii) following a scheduled event to perform the forthcoming operation, (iv) receiving a directive with the forthcoming operation in an application programming interface (API) call, etc. The forthcoming operation may be performed in at least two manners. A capability of performance of the forthcoming operation in the at least two manners may enable (i) adaptability of the data processing system in at least two scenarios, (ii) efficiency of resource utilization by the data processing system, (iii) robustness against a failure by the data processing system, etc.

After obtaining the forthcoming operation, an impact level of the forthcoming operation may be estimated. The impact level may be estimated by (i) identifying at least one pattern and/or at least one outcome from at least one similar operation to the forthcoming operation that has been performed by the data processing system, (ii) simulating the forthcoming operation in a virtual environment to observe at least one effect of the forthcoming operation, (iii) performing a risk assessment of at least one task of the forthcoming operation to identify at least one risk (e.g., a system overload, a failure, potential for a security breach, etc.), (iv) obtaining an assessment of at least one effect of the forthcoming operation from the simulation, etc.

Once the impact level has been identified, a level of autonomy for selection of a manner in which to perform the forthcoming operation may be identified. The level of the autonomy may be identified by authorizing, by an autonomy model, a measure of discretion to the data processing system in a performance of the forthcoming operation. The autonomy model may include software that can (i) ingest the impact level of the forthcoming operation and/or (ii) determine the measure of the discretion. The measure of discretion may include, for example, a less autonomous (e.g., command-driven), a partially autonomous (e.g., consensus-based), a more autonomous (e.g., self-directed), etc. performance of the forthcoming operation by the data processing system (e.g., 100). With the measure of the discretion, the autonomy model may direct how the data processing system may collaborate with at least one other data processing system of the deployment.

To direct how the data processing system may collaborate with the at least one other data processing system, the autonomy model may use a similarity map with the measure of the discretion. The similarity map may include a list of data processing systems of the deployment. For each data processing system on the list, the similarity map may include a profile of the data processing system. The profile may include, for the each of the data processing systems, attributes such as device information (e.g., a chassis identification, a port identification, a system name, etc.), network information (e.g., at least one interface name, at least one virtual local area network, a media access control address, etc.), configuration information (e.g., at least one central processing unit specification, at least one memory capacity, at least one storage capacity, etc.), etc.

Further, for the each of the data processing systems, the similarity map may include a similarity ranking. The similarity ranking may include a ranking, based on the attributes of the profile, of one data processing system compared to other data processing systems. For the data processing system, a high similarity ranking with a second data processing system may denote that first attributes of the data processing system and second attributes of the second data processing system are mostly, if not completely, similar. As well, a low similarity ranking with a third data processing system may denote that first attributes of the data processing system and third attributes of the third data processing system are mostly, if not completely, different.

The autonomy model may direct how the data processing system may collaborate with at least one other data processing system by guiding the data processing system in a selection of, using the similarity map, the at least one other data processing system based on a measure of similarity between the data processing system and/or the at least one other data processing system. If the forthcoming operation may have a low impact level, the autonomy model may enable the data processing system to select the at least one other data processing system that is mostly similar to the data processing system. However, if the forthcoming operation may have a high impact level, the autonomy model may enable the data processing system to select the at least one other data processing system that is similar and/or dissimilar to the data processing system. Selecting the at least one other data processing system that is similar and/or dissimilar may enable the data processing system to, for example, (i) learn a diverse approach to performing the forthcoming operation, (ii) utilize different resources to perform the forthcoming operation, etc.

Having selected the at least one other data processing system, the data processing system may select a manner in which to perform the forthcoming operation. The manner may be selected by (i) identifying at least one task of the forthcoming operation, (ii) identifying capabilities of the data processing system, the at least one other data processing system, etc., (iii) using, by the data processing system, the at least one other data processing system, etc. at least one inference model to simulate performance of the at least one task, (iv) measuring at least one effect of the performance of the at least one task by the data processing system, the at least one other data processing system, etc., (v) selecting, based on the at least one effect and by the data processing system, the at least one other data processing system, etc. a manner in which to perform the forthcoming operation, etc. The manner may be selected by, for example, a collaborative decision made by the data processing system, the at least one other data processing system, etc.

Finally, the forthcoming operation may be performed by (i) assigning the at least one task to the data processing system, the at least one other data processing system, etc., (ii) performing, by the data processing system, the at least one other data processing system, etc., the at least one task of the forthcoming operation, (iii) obtaining and/or storing, by the data processing system, the at least one other data processing system, etc., data generated by the at least one task, etc. By performing collaboratively, by the data processing system, the at least one other data processing system, etc., the forthcoming operation, computer implemented services may be provided by the deployment.

To provide the above noted functionality, the system may include data processing system 100 and other data processing system 110. Data processing system 100 and/or other data processing system 110 may include computing devices that provide the computer implemented services. For example, data processing system 100 and/or other data processing system 110 may independently and/or cooperatively provide the computer-implemented services. The computer implemented services may be provided to users and/or other computing devices operably connected to data processing system 100 and/or other data processing system 110.

The computer-implemented services may include any type and quantity of services including, for example, database services, instant messaging services, video conferencing services, prediction and/or inference generation services, machine learning/artificial intelligence (AI) related services, data science related services, etc. Different systems may provide similar and/or different computer-implemented services. To provide the computer-implemented services, data processing system 100 and/or other data processing system 110 may host applications and/or computer-implemented models (e.g., large language models (LLMs), generative artificial intelligence (AI) models, etc.) that provide these computer-implemented services. For example, the applications may utilize (e.g., invoke use of, etc.) one or more backend components (e.g., the computer-implemented models, policies, backend applications, data and infrastructures, etc.) to provide the computer-implemented services.

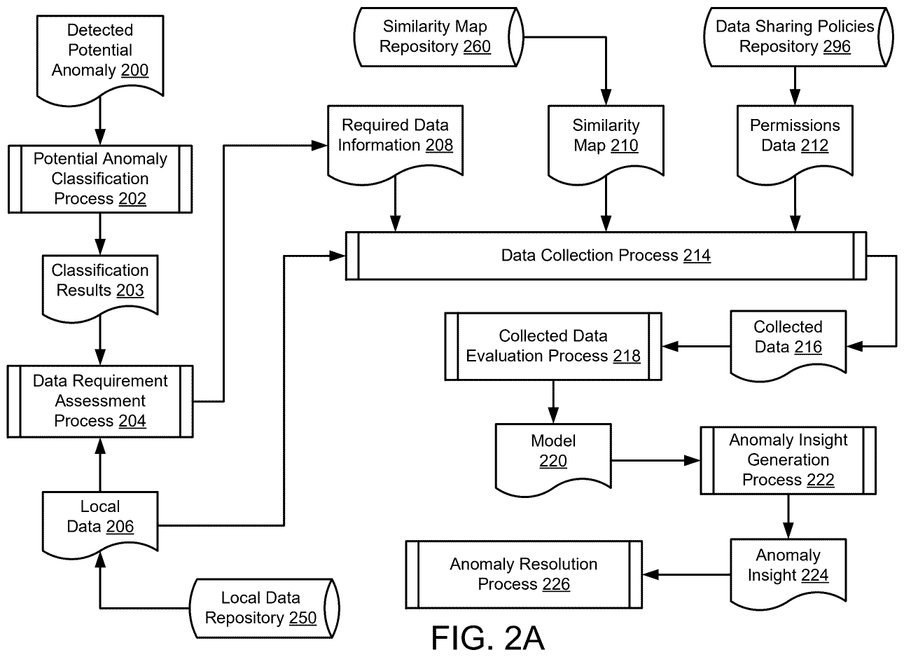

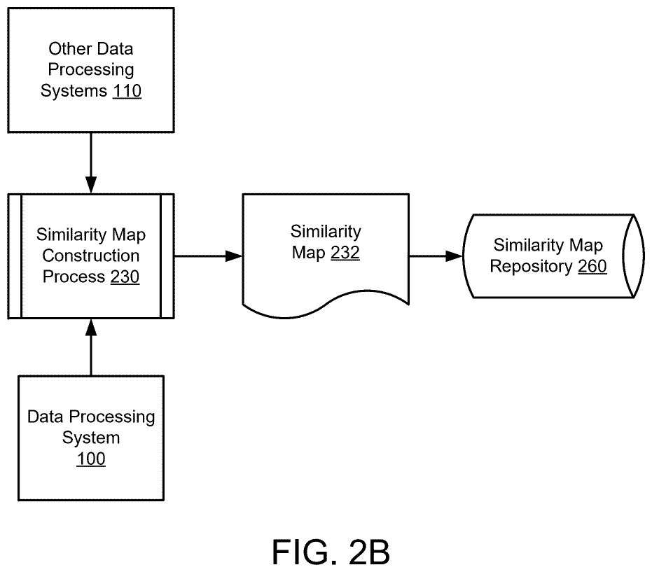

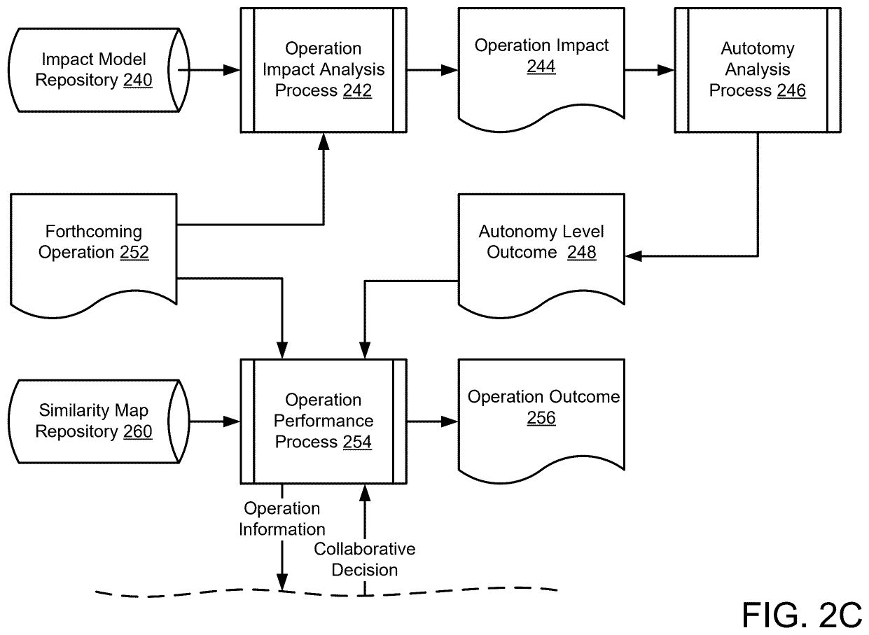

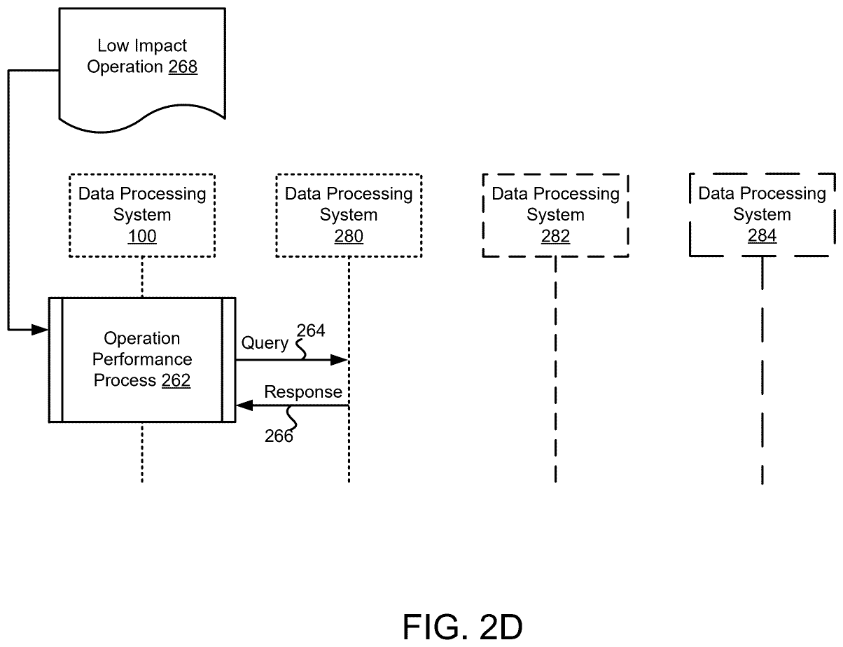

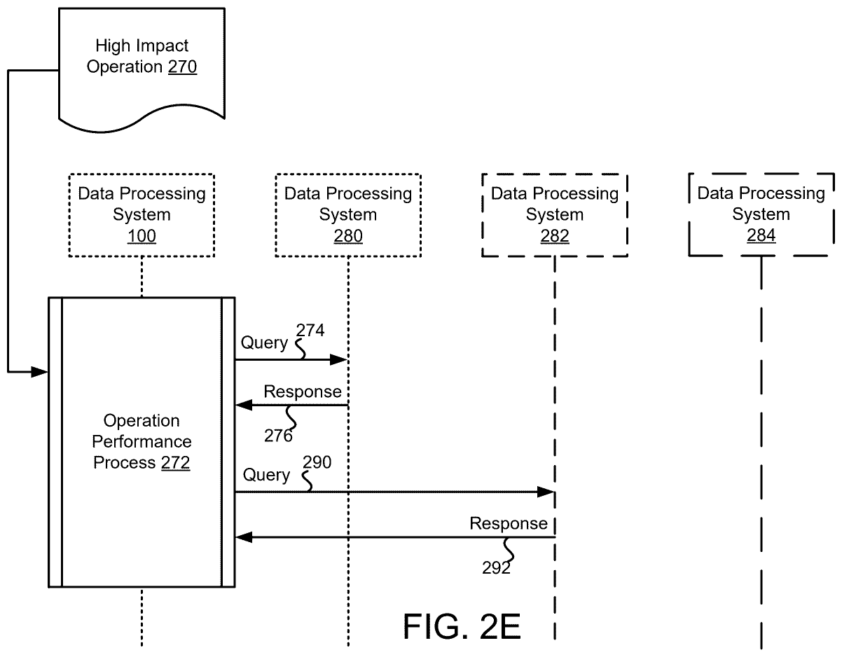

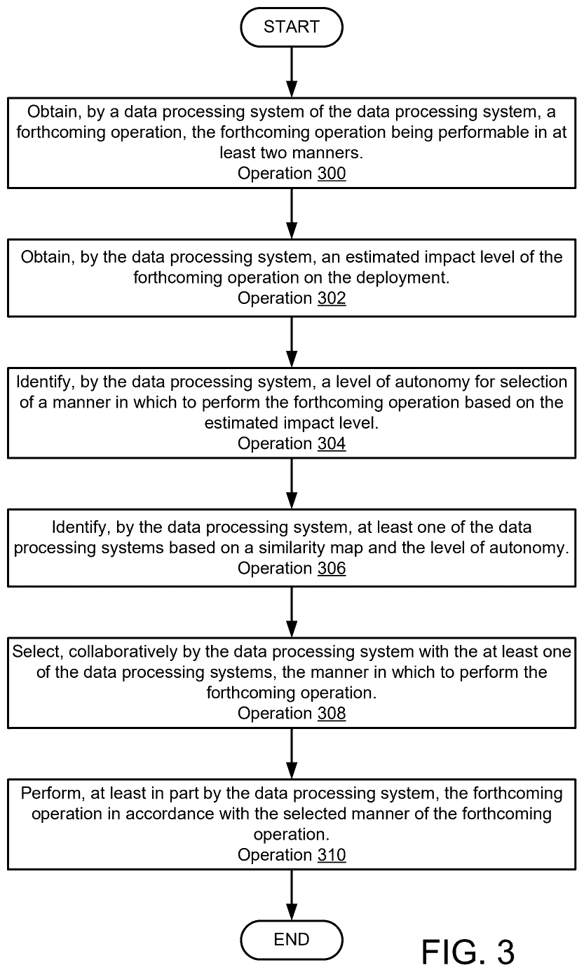

While providing their functionality, any of data processing system 100 and other data processing system 110 may perform all, or a portion, of the flows and methods shown in FIGS. 2A-3.

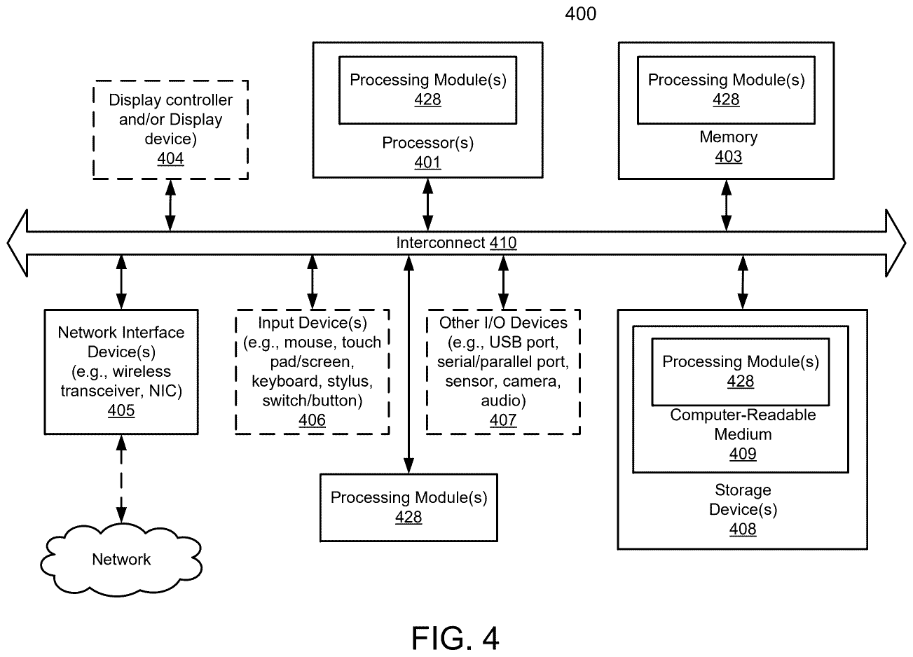

Any of (and/or components thereof) data processing system 100 and other data processing system 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 105. In an embodiment, communication system 105 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 203, etc.) is used to represent data structures, a second set of shapes (e.g., 202, 204, etc.) is used to represent processes performed using and/or that generate data, and a third set of shapes (e.g., 250, 260, etc.) is used to represent large scale data structures such as databases, etc.

Turning to FIG. 2A, a first data flow diagram in accordance with an embodiment is shown. The first data flow diagram may illustrate data used in and data processing performed in resolving an anomaly that has been detected by a data processing system (e.g., 100).

As shown in FIG. 2A, a data processing system (e.g., 100) may obtain detected potential anomaly 200. The detected potential anomaly may include any type of data (e.g., telemetry data, system metrics, operational data/metrics, system log data, application data, etc.) that can be gathered by the data processing system (e.g., 100) from itself (e.g., its own components and operations). For example, the detected potential anomaly 200 may include data indicative of an unusual spike in central processing unit (CPU) usage. The detected potential anomaly 200 may also include data indicative of other changes in other system metrics such as memory consumption, etc.

In embodiments, to be able to obtain the detected potential anomaly 200, the data processing system (e.g., 100) may be configured to locally manage its own data. In particular, the data processing system (e.g., 100) may be configured to autonomously manage its own operational data by gathering data such as (i) telemetry data including performance metrics (e.g., CPU usage, memory consumption, network throughput, error logs, etc.), (ii) application data such as data generated by applications (e.g., user activity logs, transaction records, sensor data, etc.) running on the data processing system (e.g., 100), etc. Other types of data about itself may be gathered by the data processing system (e.g., 100) without departing from the scope of embodiments disclosed herein.

Once gathered, the data processing system (e.g., 100) may classify and profile each of the gathered data by (i) organizing data into categories based on type, source, usage, etc. to facility faster access, (ii) implement data retention policies, etc. for determining how long different types of data are stored, ensuring that storage resources are used efficiently, (iii) ensuring that all stored data (or all sensitive data) is encrypted to protect sensitive information from unauthorized access, etc. Other types of data classification and profiling (e.g., data processing) mechanisms may be used without departing from the scope of embodiments disclosed herein.

Once gathered and processed (e.g., classified and profiled), the data processing system (e.g., 100) may store the data in local data repository 250 as local data 206. In embodiments, the detected potential anomaly 200 may be obtained during such data gathering and processing processes (e.g., while the processes are being performed before the data is stored in local data repository 250) by the data processing system (e.g., 100). Alternatively, or in addition, the detected potential anomaly 200 may be obtained from local data repository 250 at any time (e.g., during routine checks of the data within local data repository 250, etc.).

For example, in embodiments, the data processing system (e.g., 100) may be configured to detect irregularities within the gathered data and/or within the local data 206 stored in local data repository 250. For example, the data processing system (e.g., 100) may be configured to use statistical methods and/or machine learning models to detect unusual patterns in the data. Once detected, the observed and/or detected irregularities may be obtained as the detected potential anomaly 200.

Turning back to FIG. 2A, the detected potential anomaly 200 may be ingested (e.g., by the data processing system (e.g., 100)) into potential anomaly classification process 202. In particular, as part of potential anomaly classification process 202, the data processing system (e.g., 100) may analyze the detected potential anomaly (e.g., using pre-stored algorithms, statistical models, machine learning models, sets of rules or policies, etc.) to assign an anomaly classification to the detected potential anomaly 200.

In embodiments, the anomaly classification may include (i) a simple solution classification indicating that the detected potential anomaly 200 could potentially be analyzed without using machine learning (e.g., using a threshold-based alert analysis, etc.), and/or (ii) a complex solution classification indicating that the detected potential anomaly 200 must be analyzed using machine learning. Although only two types of classifications are described here, other types and numbers of classifications may be used without departing from the scope of embodiments disclosed herein.

The anomaly classification generated from the potential anomaly classification process 202 may be included in classification results 203. Classification results 203 may be ingested by the data processing system (e.g., 100) into data requirement assessment process 204.

In embodiments, as part of data requirement assessment process 204, the data processing system (e.g., 100) may determine (e.g., assess, decide, etc.), using the anomaly classification, what processes (e.g., running local diagnostics without or without training (or even using) a machine learning model, etc.) and data will be required to accurately analyze the detected potential anomaly 200.

To determine the necessary processes and data, data requirement assessment process 204 may also access the local data 206 stored in local data repository 250. In particular, data requirement assessment process 204 may be configured to determine, using the anomaly classification and the local data 206, whether the data processing system (e.g., 100) itself has enough data (e.g., in the form of local data 206) or whether the data processing system (e.g., 100) will need additional data (e.g., from other sources) to accurately analyze the detected potential anomaly 200. Any type of techniques and/or mechanisms (e.g., involving use of one or more using pre-stored algorithms, statistical models, machine learning models, sets of rules or policies, etc.) may be used by data processing system (e.g., 100) to reach this determination without departing from the scope of embodiments disclosed herein.

The results of the data requirement assessment process 204 (e.g., whether the data processing system (e.g., 100) itself has enough data (e.g., in the form of local data 206) or whether the data processing system (e.g., 100) will need additional data (e.g., from other sources) to accurately analyze the detected potential anomaly 200) may be included (e.g., stored) in required data information 208.

In embodiments, required data information 208 may be ingested into data collection process 214 where the data processing system (e.g., 100) is configured to collect the required data indicated in the required data information 208. Additionally, similarity map 210 and permissions data 212 may be ingested, along required data information 208, into data collection process 214.

In embodiments, the data processing system (e.g., 100) includes a similarity map repository 260 (that is implemented as a different or the same component as local data repository 250) that stores the similarity map 210.

Similarity map 210 may be compiled, updated, and distributed to each data processing system (e.g., 100) by a second data processing system (e.g., 110, etc.). Alternatively, or in addition to the above, each data processing system (e.g., 100, 110, etc.) may also update each own locally stored similarity map 210.

In embodiments, similarity map 210 includes data that provides each data processing system (e.g., 100, 110, etc.) with a multi-dimensional view of the computer infrastructure (e.g., the system of FIG. 1) in which the data processing system (e.g., 100) belongs. In particular, the similarity map 210 may include a spatial attribute (e.g., the physical or virtual location) of each data processing system (e.g., 100, 110, etc.) within the computer infrastructure and infrastructural attributes (e.g., processing power, memory, data types handled, computer-implemented services provided, etc.) of each data processing system (e.g., 100, 110, etc.).

More specifically, the similarity map 210 may be a network topology map created in unison by all of the data processing systems (e.g., 100, 110, etc.) making up the computer infrastructure (e.g., the system of FIG. 1). For example, data processing systems (e.g., 100, 110, etc.) on the same LAN may ping and query one another (as well as network switches and routers) to produce such a network topology map. In particular, each data processing system (e.g., 100, 110, etc.) may share (e.g., with its neighboring data processing systems, etc.) its system configuration data (e.g., configuration data on its components such as the CPU, memory, hard drive (HD) and/or solid state drive (SSD) storage, operating system (OS), etc.). Each data processing system (e.g., 100, 110, etc.) may also share a list of telemetry data (e.g., system temperature, CPU utilization, memory utilization, disk input/output (IO), etc. that the data processing system is capable of collecting). Each data processing system (e.g., 100, 110, etc.) may further share its workload characteristics (e.g., average (AVG) temperature operating temperature range, AVG CPU utilization, max/min CPU utilization, memory utilization, disk utilization, etc.). Other data (e.g., data stored as local data 206 in each data processing system (e.g., 100, 110, etc.)) may also be shared to create the similarity map 210 without departing from the scope of embodiments disclosed herein.

Using similarity map 210, each data processing system (e.g., 100, 110, etc.) may advantageously gain self-awareness about its positioning within the infrastructure (e.g., the system of FIG. 1) and gain awareness of other data processing systems (e.g., 100, 110, etc.) within the infrastructure. In particular, from the spatial and infrastructural attributes included in the similarity map 210, each data processing system (e.g., 100, 110, etc.) may advantageously (i) identify relevant neighboring data processing systems (e.g., by understanding its own position within the similarity map, the data processing system (e.g., 100) can determine which the other data processing systems (e.g., 110, etc.) are most relevant for collaboration based on proximity and resource availability), (ii) optimize communication (e.g., data processing systems (e.g., 100, 110, etc.) can prioritize communication with closer or more resource-efficient neighbors, reducing latency and improving response times), (iii) enhance fault tolerance (e.g., by knowing its position and neighbors, a data processing system can reroute tasks and data if a neighboring data processing system fails, ensuring continuous operation), etc.

Detailed examples of how the similarity map 210 is used during data collection process 214 will be described below in reference to the implementation examples of embodiments disclosed herein.

In embodiments, the data processing system (e.g., 100) includes a data sharing policies repository 296 (that is implemented as a different or the same component as local data repository 250 and/or the similarity map repository 260) that stores the permission data 212.

Additionally, the data processing system (e.g., 100) may be configured to include a data sharing agent (e.g., implemented in hardware, software, or a combination thereof such as an application processing interface (API), etc.) that compiles and manages the permissions data 212. The data sharing agent may also be configured to help each data processing system (e.g., 100, 110, etc.) share data securely and/or efficiently with other data processing systems (e.g., 100, 110, etc.) within the infrastructure.

In embodiments, the data sharing agent may be configured to have functions and capabilities such as (i) authentication and authorization capabilities that ensure only authorized data processing systems (e.g., 100, 110, etc.) are able to access data stored on other data processing systems (e.g., each data processing system (e.g., 100, 110, etc.) must authenticate itself to all other data processing systems (e.g., 100, 110, etc.) from which it wishes to retrieve data (e.g., local data 206 of each data processing system (e.g., 100, 110, etc.), etc.) using secure tokens, certificates, etc.), (ii) query interface capabilities that allow data processing systems (e.g., 100, 110, etc.) to request specific datasets from other data processing systems (e.g., queries may be tailored based on data type, time, range, etc.), (iii) data transfer protocol capabilities that utilize efficient and secure data transfer protocols (e.g., Hypertext Transfer Protocol Secure (HTTPS), gRPC Remote Procedure Calls (gRPC), etc.) to ensure data integrity and minimize transfer times, (iv) data format standardization capabilities that endure that shared data is sin a standardized format (e.g., JavaScript Object Notation, Extensible Markup Language, etc.) for easy parsing and integration by the receiving data processing system (e.g., 100, 110, etc.), (v) rate limiting and quotas capabilities where rate limiting and data quotas may be implemented to prevent abuse and ensure fair resource usage across the network, (vi) logging and auditing capabilities that keep detailed logs of data sharing activities for auditing and troubleshooting purposes, etc. The data sharing agent may have other functions and capabilities not discussed above without departing from the scope of embodiments disclosed herein.

In embodiments, the permissions data 212 may include the required permissions for accessing stored data from each data processing system (e.g., 100, 110, etc.) within the infrastructure. Given appropriate data access permissions (e.g., using the data stored in permissions data 212), data processing systems (e.g., 100, 110, etc.) can filter and select (e.g., through interaction of a data processing system's data sharing agent with another data processing system's data sharing agent) usable data from the other data processing systems (e.g., 110, etc.).

For example, using permissions data 212, the data sharing agent of the data processing system (e.g., 100) may: (i) issue specific queries to retrieve data relevant to the problem a data processing system is experiencing (e.g., the data listed in required data information 208), ensuring that only necessary data is transferred between data processing systems (e.g., 100, 110, etc.), (ii) ensuring that data sharing adheres to each data processing system's security and privacy policies, with permissions controlling which data processing systems (e.g., 100, 110, etc.) can access which data, (iii) applying filters to select only the most relevant data (e.g., associated with the data listed in required data information 208), optimizing bandwidth usage and reducing unnecessary data processing, etc.), etc.

Such mechanisms (e.g., selective access mechanisms) implemented by the data sharing agent using permissions data 212 advantageously allows the data processing system (e.g., 100) to gather precise data needed for analyzing detected potential anomaly 200 while minimizing overhead and maintaining security.

In embodiments, using required data information 208 in connection with similarity map 210, permissions data 212, and/or local data 206 from local data repository 250, data collection process 214 may generate collected data 216 (also referred to herein as “a set of data required for analyzing the potential anomaly”). Collected data 216 may include all data determined (e.g., using required data information 208 in connection with similarity map 210, permissions data 212, and/or local data 206 from local data repository 250) by the data processing system (e.g., 100) to be required for accurately analyzing (e.g., locally analyzing) the detected potential anomaly 200.

In embodiments, the data processing system (e.g., 100) may ingest collected data 216 into collection data evaluation process 218 to generate one or more models 220. Depending on the anomaly classification determined in potential anomaly classification process 202, the model(s) 220 may be one or more machine learning-based models, one or more non machine learning-based models, or a combination of both.

For example, if the detected potential anomaly 200 was classified as a simple solution classification, the model(s) 220 may be one or more non-machine learning-based models (e.g., statistical models, threshold-based models, etc.). Additional examples and details will be described below in reference to the implementation examples of embodiments disclosed herein.

In embodiments, data processing system (e.g., 100) may ingest the model(s) 220 and the detected potential anomaly 200 into anomaly insight generation process 222 to obtain (e.g., generate) an anomaly insight 224. In particular, the detected potential anomaly 200 may be used as input data and compared to the information included in the model(s) 220 to obtain the anomaly insight 224. Anomaly insight may indicate whether the detected potential anomaly 200 is an actual (e.g., real) anomaly (or a false alarm). An actual anomaly may be an irregularity that could cause the data processing system (e.g., 100) to fail in its entirety (or a specific component within the data processing system (e.g., 100) to fail and require replacement). Additional examples and details will be described below in reference to the implementation examples of embodiments disclosed herein.

In embodiments, collected data evaluation process 218 and anomaly insight generation process 222 may be part of a local processing mechanism performed by the data processing system (e.g., 100). In particular, using the local processing mechanism, each data processing system (e.g., 100, 110, etc.) may leverage their computational capabilities to perform necessary data processing and model training locally including, for example: (i) statistical analysis for performing basic statistical analyses to gain insights from data quickly, (ii) machine learning including training and deploying machine learning models using the collected data 216 to predict trends, detect anomalies, or optimize performance, (iii) real-time processing for handling time-sensitive tasks directly on the data processing system (e.g., 100) to ensure timely responses without waiting for central processing, etc.

By enabling each data processing system (e.g., 100, 110, etc.) within the infrastructure to include such local processing mechanisms to process collected data based on each data processing system's self-awareness within the infrastructure, each data processing system (e.g., 100, 110, etc.) may advantageously provide faster insights and actions and reduce dependency on a central processing entity (thus removing each data processing system (e.g., 100, 110, etc.) from the limitations associated with relying on such a central processing entity).

In embodiments, data processing system (e.g., 100) may ingest anomaly insight 224 into an anomaly resolution process 226 to obtain (e.g., generate, determine, etc.) one or more anomaly resolution actions (e.g., to resolve the actual anomaly and obtain an anomaly resolved data processing system (e.g., 100)). Such anomaly resolution actions may include, for example, (i) notifying a user (e.g., admin) of the data processing system (e.g., 100), (ii) automatically perform one or more update/troubleshooting mechanisms to resolve the anomaly, (iii) do nothing is the detected potential anomaly 200 is not actually an anomaly, (iv) initiate automatic requests for part and/or component replacements (e.g., automatically transmit a request for a replacement CPU or SDD to be physically delivered to the location where the data processing system (e.g., 100) is at so that the replacement CPU or SDD can be installed into the data processing system (e.g., 100), etc.), etc.

Implementation examples of the processes discussed in the data flow diagram of FIG. 2A will now be discussed. A first implementation example will be described with respect to a simple case that does not require machine learning techniques for the anomaly analysis and resolution by the data processing system (e.g., 100).

In particular, in the first implementation example, a data processing system (e.g., 100) detects a usual spike in its CPU usage. This spike is significant enough to warrant further investigation, but it is isolated, with no other apparent anomalies in other metrics.

Upon determining this spike (e.g., as detected potential anomaly 200), the data processing system (e.g., 100), may determine (e.g., as part of potential anomaly classification process 202 and data requirement assessment process 204) that it only needs CPU usage data from similar data processing systems (e.g., 110, etc.) to calculate a threshold (for comparing the spike to) in order to determine whether spike in the CPU usage is an actual anomaly.

Based on this determination (e.g., as part of data collection process 214), the data processing system (e.g., 100) can identify and query neighboring data processing systems (e.g., similar neighboring data processing systems) for their recent CPU usage data (while also ensuring that the data processing system (e.g., 100) has the necessary permissions to access such data). Said another way, the data processing system (e.g., 100) may retrieve CPU metrics from neighboring data processing systems with similar functions and configurations (e.g., using the self-awareness it has gained from the similarity map 210) as the data processing system (e.g., 100).

With the collected CPU data, the data processing system (e.g., 100) may generate (e.g., as part of collected data evaluation process 218) a non-machine learning-based model (e.g., by calculating a threshold for what should be normal CPU usage).

The data processing system (e.g., 100) may then (e.g., as part of anomaly insight generation process 222 and anomaly resolution process 226) compare the initially detected spike in CPU usage to the calculated threshold (e.g., included in the non-machine learning-based model) to determine whether the spike is an actual anomaly. For example, if the detected spike in CPU usage exceeds the calculated threshold, an alert may be triggered by the data processing system (e.g., 100) and the data processing system (e.g., 100) may perform other processes (e.g., reallocating resources and/or restarting services) to resolve the anomaly.

A second implementation example will now be described with respect to a complex case that does require use of one or more machine learning techniques for the anomaly analysis and resolution by the data processing system (e.g., 100).

In the second implementation example, the data processing system (e.g., 100) detects an unusual spike in CPU usage. Along with the usual spike in CPU usage, the data processing system (e.g., 100) also detects changes in other system metrics, such as memory consumption and IOPS (Input/Output Operations Per Second). These combined changes (e.g., detected potential anomaly 200) suggest a more complex situation that may require comprehensive analysis to determine if the CPU spike is genuinely anomalous.

Based on such detected data, the data processing system (e.g., 100) determines (e.g., as part of potential anomaly classification process 202 and data requirement assessment process 204), that it needs a broader dataset, including additional metrics such as memory consumption and input/output operations per second (IOPS), to accurately identify the anomaly. It also seeks labeled data (if available as part of local data 206) that contains known alerts or issues to help train a more accurate model. If labeled data is not available, it collects the necessary data as unlabeled data.

In particular, the data processing system (e.g., 100) identifies and queries (e.g., as part of data collection process 214) neighboring data processing systems (e.g., 110, etc.) for a more extensive dataset, including CPU usage, memory consumption, and IOPS. It also requests any available labeled data indicating known anomalies or alerts. If labeled data is not available, it collects the necessary metrics as unlabeled data.

Once the data has been collected (e.g., as collected data 216), the data processing system (e.g., 100) may use a supervised approach or an unsupervised approach for generating one or more machine learning models (e.g., as model 220 using collected data evaluation process 218). For example, using the supervised approach (e.g., if labeled data is available), the data processing system (e.g., 100) uses the labeled data to train a supervised classification model (e.g., a decision tree or a neural network, etc.). This model learns to distinguish between normal and anomalous behavior based on the combined metrics.

Using the unsupervised approach (e.g., if only unlabeled data is available), the data processing system (e.g., 100) applies unsupervised clustering techniques (e.g., k-means clustering, Density-Based Spatial Clustering of Applications with Noise (DBSCAN), etc.) to identify patterns and outliers in the data. This approach helps the data processing system (e.g., 100) detect anomalies based on the clustering results.

In the supervised approach (and as part of anomaly insight generation process 222 and anomaly resolution process 226), the data processing system (e.g., 100) uses the trained classification model to evaluate the current metrics. If the model predicts an anomaly, the data processing system (e.g., 100) triggers alerts or takes automated actions (e.g., performs the one or more anomaly resolution actions). In the unsupervised approach, the data processing system (e.g., 100) analyzes the clustering results to identify whether its current metrics fall into an anomalous cluster. If so, data processing system (e.g., 100) triggers alerts or takes automated actions to address the detected issue.

In embodiments, at any time during the processes discussed in the data flow diagram of FIG. 2A, the data processing system (e.g., 100) may determine that it does not have the computational resources (e.g., enough limited computing resources) to complete the analysis of the detected potential anomaly. Such determination may be based, for example, on one or more predetermined set of rules set by the user or any other similar and/or suitable means. For example, if at potential anomaly classification process 202 the data processing system (e.g., 100) determines that machine learning models are required but (e.g., based on one or more pre-defined rules or policies, its own analysis of its system capabilities, etc.) it does not have sufficient limited computing resources to be able to train and use such machine learning models, data processing system (e.g., 100) may then provide all of the currently obtained results and data (e.g., classification results 203 and detected potential anomaly 200) along with is local data 206 to, for example, a second data processing system (e.g., 110) to perform the anomaly analysis and resolution.

Thus, via the first data flow illustrated in FIG. 2A, a system in accordance with an embodiment may resolve the anomaly that has been detected by a data processing system (e.g., 100). Consequently, the data processing system (e.g., 100) may be more likely to be able to provide desired computer implemented services by collaborating with at least one other data processing system (e.g., 110) to perform an analysis of and/or mitigate, remove, etc. at least one effect of the anomaly.

Turning to FIG. 2B, a second data flow diagram in accordance with an embodiment is shown. The second data flow diagram may illustrate data used in and data processing performed in constructing a similarity map.

To construct a similarity map, similarity map construction process 230 may be performed. During similarity map construction process 230, a data processing system (e.g., 100) in a system of data processing systems (e.g., 100, 110, etc.) may be assigned to construct the similarity map. The data processing system (e.g., 100) may be assigned by being allocated at least one task by at least one other data processing system (e.g., 110, etc.). The at least one task may be allocated to the data processing system (e.g., 100) by receiving the at least one task from the at least one other data processing system (e.g., 110, etc.). The at least one task may be received through a communication protocol of a communication system (e.g., 105) by which the at least one other data processing system (e.g., 110, etc.) communicates to the data processing system (e.g., 100). The at least one task may be sent using a message queue, a data stream, shared memory, etc.

After receiving the at least one task, the data processing system (e.g., 100) may perform the at least one task. The at least one task may include (i) obtaining a first list of each of the data processing systems (e.g., 100, 110, etc.), (ii) generating a second list of information to request from the each of the data processing systems, (iii) sending at least one request to the each of the data processing systems for the information, (iv) receiving at least one response from the each of the data processing systems, (v) populating a data structure with the information from the at least one response from the each of the data processing systems to generate the similarity map, (vi) storing the similarity map in a similarity map repository (e.g., 260).

The first list may be obtained by (i) querying a data processing system repository for the first list of all the data processing systems in the system of the data processing systems (e.g., 100, 110, etc.), (ii) sending a message to the each of the data processing systems (e.g., 100, 110, etc.), (iii) receiving a response from the each of the data processing systems (e.g., 100, 110, etc.), (iv) extracting an identification from the response, and/or (v) adding the identification to the first list.

The second list of may be generated by enumerating attributes. The attributes may include (a) device information, (b) network information, (c) configuration information, (d) workload information. The device information may include (a) a chassis identification, a port identification, a port description, a system name, a system description, at least one capability of the data processing system, etc. The network information may include (a) a virtual local area network of which the data processing system is a member, (b) a media access control address assigned to the data processing system, (c) link information between the data processing system and others of the data processing systems, etc. The configuration information may include (a) at least one central processing unit specifications, (b) a memory capacity, (c) a storage capacity, (d) at least one software specification, etc. The workload information may include (a) an average central processing unit utilization, (b) a maximum central processing unit utilization, (c) a minimum central processing unit utilization, (d) an average memory utilization, I at least one application running schedules, etc.

The at least one request may be sent by transmitting the at least one request through the communication protocol of a communication system (e.g., 105) to the each of the data processing systems. The at least one request may be transmitted using the message queue, the data stream, the shared memory, etc.

The at least one response may be received by obtaining the at least one response through at least one transmission using the communication protocol of the communication system (e.g., 105) to the each of the data processing systems. The at least one response may be transmitted using the message queue, the data stream, the shared memory, etc.

The data structure may be populated by writing the attributes from the at least one response to the data structure to generate the similarity map (e.g., 232). The data structure may include a map, an array, a list, etc. The attributes may include (a) the device information, (b) the network information, (c) the configuration information, (d) the workload information, etc. of the each of the data processing systems.

In addition, for the each of the data processing systems (e.g., 100, 110, etc.), a similarity ranking may be generated and included in the similarity map (e.g., 232). The similarity ranking may include a ranking, based on the attributes of a profile, of one data processing system (e.g., 100) compared to other data processing systems (e.g., 110, etc.). For the one data processing system (e.g., 100), a high similarity ranking with a second data processing system (e.g., 110) may denote that first attributes of the data processing system (e.g., 100) and second attributes of the second data processing system (e.g., 110) are mostly, if not completely, similar. As well, a low similarity ranking with a third data processing system (e.g., not 100, not 110, etc.) may denote that first attributes of the data processing system (e.g., 100) and third attributes of the third data processing system (e.g., not 100, not 110, etc.) are mostly, if not completely, different.

Finally, the similarity map (e.g., 232) may be stored in the similarity map repository (e.g., 260). The similarity map (e.g., 232) may be stored by committing the similarity map (e.g., 232). Further, at least one revision of the similarity map (e.g., 232) may be tracked when at least one attribute of at least one data processing system of the data processing systems is modified, updated, etc. The similarity map repository (e.g., 260) may include at least one similarity map (e.g., 232) of at least one network of data processing systems (e.g., 100, 110, etc.).

Thus, via the second data flow illustrated in FIG. 2B, a system in accordance with an embodiment may construct a similarity map. Consequently, the data processing system (e.g., 100) with first attributes may be more likely to be able to provide desired computer implemented services by (i) retrieving a similarity map (e.g., 232) and (ii) conducting a search for at least a second data processing system (e.g., 110) having at least second attributes that have some measure of similarity to the first attributes.

Turning to FIG. 2C, a third data flow diagram in accordance with an embodiment is shown. The third data flow diagram may illustrate data used in and data processing performed in performing, in a collaboration by at least two data processing systems, an operation.

To perform the operation, operation impact analysis process 242 may be performed. During operation impact analysis process 242, a forthcoming operation (e.g., 252) may be considered for performance by a data processing system (e.g., 100). The forthcoming operation (e.g., 252) may include (i) migrating data from a local database to a cloud database, (ii) developing a new machine learning model for at least one predictive analysis, (iii) utilizing a new data backup and recovery strategy, etc.

Depending on at least one detail of the forthcoming operation (e.g., 252), an impact model may be obtained from an impact model repository (e.g., 240). The impact model may, for example, (i) evaluate an impact of the forthcoming operation on, for example, speed and/or capacity of a data processing system that performs the forthcoming operation, (ii) evaluate the impact of adding more data processing systems to perform with an increased workload by the forthcoming operation, (iii) evaluate an impact on security of at least one data processing system that performs the forthcoming operation, etc.

During operation impact analysis process 242, after at least one impact model has been obtained from the impact model repository (e.g., 240) and/or the forthcoming operation (e.g., 252) has been selected by an administrator, the data processing system (e.g., 100), a user, etc., an impact analysis may be performed. To perform the impact analysis, at least one simulation may be conducted by the data processing system (e.g., 100) with the impact model. The simulation may ingest the forthcoming operation (e.g., 252), as well as historical data and/or current data that can be used in the forthcoming operation (e.g., 252). Further, at least one parameter (throughput, latency, response time, at least one resource, etc.) may be adjusted to vary an operation impact (e.g., 244)

The operation impact (e.g., 244) may be generated by the impact model. The outcome impact (e.g., 244) may include at least one measurable effect of performing the forthcoming operation (e.g., 252) by the data processing system (e.g., 100). Specific examples of the at least one measure effect may include (i) a measure of greenhouse gas emission, energy consumption, waste generation, etc. in a manufacturing operation, (ii) revenue change, cost savings, profit margin, etc. in a financial operation, (iii) system uptime, error frequency, new product development rates, etc. of a new technology, etc.

The operation impact (e.g., 244) may include short-term effects and/or long-term effects that occur during the forthcoming operation (e.g., 252). The short-term effects may appear at any time during the forthcoming operation (e.g., 252) and/or disappear within a short period of time. The long-term effects may appear at any time during the forthcoming operation (e.g., 252) and/or persist for a long period of the time. The short-term effects and/or the long-term effects may contribute to any variation in the operation impact (e.g., 244).

Based on the at least one measurable effect and/or the short-term effects and/or long-term effects of the operation impact (e.g., 244) autonomy analysis process 246 may be performed. During autonomy analysis process 246, an autonomy model may ingest the operation impact (e.g., 244) to determine an autonomy level outcome (e.g., 248). The autonomy level outcome (e.g., 248) may include a level of the autonomy that can be identified by granting, by an autonomy model, a measure of discretion to the data processing system (e.g., 100) in a performance of the forthcoming operation. The measure of discretion may include a less autonomous (e.g., command-driven), a partially autonomous (e.g., consensus-based), a more autonomous (e.g., self-directed), etc. performance of the forthcoming operation (e.g., 252) by the data processing system (e.g., 100). With the measure of the discretion, the autonomy model may direct how the data processing system (e.g., 100) may collaborate with at least one other data processing system (e.g., 110, etc.) of the deployment.

During autonomy analysis process 246, the autonomy model may determine the autonomy level outcome (e.g., 248) by assessing a magnitude (e.g., high, low, moderate, etc.) of the operation impact (e.g., 244). Based on the magnitude, the autonomy model may, using the autonomy level outcome (e.g., 248), direct how the data processing system (e.g., 100) may collaborate with at least one other data processing system during operation performance process 254.

The autonomy model may direct how the data processing system (e.g., 100) may collaborate by guiding the data processing system (e.g., 100) in a selection of, using a similarity map (e.g., 232) from a similarity map repository (e.g., 260), the at least one other data processing system (e.g., 110, etc.) based on a measure of similarity between the data processing system (e.g., 100) and the at least one other data processing system (e.g., 110). If the forthcoming operation (e.g., 252) has a low impact level (i.e., from the operation impact (e.g., 244)), the autonomy model may enable the data processing system (e.g., 100) to select the at least one other data processing system (e.g., 110, etc.) that is mostly similar to the data processing system (e.g., 100). However, if the forthcoming operation has a high impact level (i.e., from the operation impact (e.g., 244)), the autonomy model may enable the data processing system (e.g., 100) to select the at least one other data processing system (e.g., 110, etc.) that is similar and/or dissimilar to the data processing system (e.g., 100).

Selecting, by the data processing system (e.g., 100), the at least one other data processing system (e.g., 110, etc.) that is similar and/or dissimilar may enable the data processing system (e.g., 100) to, for example, (i) learn a diverse approach to performing the forthcoming operation, (ii) utilize different resources to perform the forthcoming operation, etc. The data processing system (e.g., 100) may, for example, (i) learn the diverse approach, (ii) utilize the different resources, etc. by (i) passing operation information to the at least one other data processing system (e.g., 110, etc.) and/or (ii) reaching at least one collaborative decision with the at least one other data processing system (e.g., 110, etc.).

In a collaboration with the at least one other data processing system (e.g., 110, etc.) for performance of the forthcoming operation (e.g., 252), operation outcome (e.g., 256) may be generated. The operation outcome (e.g., 256) may include the at least one measurable effect (which may be included in the operation impact (e.g., 244)) and/or at least one result of performing the forthcoming operation (e.g., 252) by the data processing system (e.g., 100) and/or the at least one other data processing system (e.g., 110, etc.). However, by performing the forthcoming operation (e.g., 252) in the collaboration, the at least one measurable effect (from the operation impact (e.g., 244)), at least one short-term effect and/or at least one long-term effect of the forthcoming operation (e.g., 252) may not be observed.

The at least one measurable effect (from the operation impact (e.g., 244)), the at least one short-term effect and/or the at least one long-term effect may not be observed because the collaboration may have resulted in a new approach to performing the forthcoming operation (e.g., 252).

For example, a first data processing system (e.g., 100) may perform spam detection of incoming e-mails for a business using certain keywords. However, an approach using basic keyword detection to filter e-mails may incorrectly flag and/or trash legitimate e-mails, which can have a measurable impact on commerce in a business that uses the first data processing system (e.g., 100).

To enable for more accurate spam detection of the e-mails, a second data processing system (e.g., 110) may be used. The second data processing system (e.g., 110), selected from the similarity map (e.g., 232), may be used by (i) receiving a flagged e-mail from the first data processing system (e.g., 100) and (ii) sending the flagged e-mail to a trained inference model to generate an output. The output may include a determination of whether the flagged e-mail is spam. Further, the second data processing system (e.g., 110) may use historical e-mails, already determined to be spam, to train and/or update the inference model.

Thus, via the third data flow illustrated in FIG. 2C, a system in accordance with an embodiment may perform, in the collaboration by the at least two data processing systems, the operation. Consequently, the data processing system (e.g., 100) may be more likely to be able to provide desired computer implemented services by leveraging combined computational resources of data processing systems.

To further clarify embodiments disclosed herein, interactions diagrams in accordance with an embodiment are shown in FIGS. 2D-2E. These interactions diagrams may illustrate how data may be obtained and used within the system of FIGS. 2D-2E.

In the interaction diagrams, processes performed by and interactions between components of a system in accordance with an embodiment are shown. In the diagrams, components of the system are illustrated using a first set of shapes (e.g., 100, 280, etc.), located towards the top of each figure. Lines descend from these shapes. Processes performed by the components of the system are illustrated using a second set of shapes (e.g., 262, 272, etc.) superimposed over these lines. Interactions (e.g., communication, data transmissions, etc.) between the components of the system are illustrated using a third set of shapes (e.g., 264, 266, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 264 may occur prior to the interaction labeled as 266. However, it will be appreciated that the processes and interactions may be performed in different orders, any may be omitted, and other processes or interactions may be performed without departing from embodiments disclosed herein.

Turning to FIG. 2D, a first interaction diagram in accordance with an embodiment is shown. The first interaction diagram may illustrate data used in and data processing performed in collaborating, by two data processing systems (e.g., 100, 280, etc.), to perform a low impact operation (e.g., 268).

To perform the low impact operation (e.g., 268), operation performance process 262 may be performed. During operation performance process 262, at least one task of a low impact operation (e.g., 268) may be performed by a first data processing system (e.g., 100) and/or a second data processing system (e.g., 280). The at least one task may be included in the low impact operation because the at least one task may consume minimal resources (e.g., memory, storage, etc.) of a system, have a negligible operation impact (e.g., 244) on a functionality of the system, etc.

Because the at least one task may consume minimal resources (e.g., the memory, the storage, etc.), have the negligible operation impact (e.g., 244), etc., performance of the at least one task may be assigned to the first data processing system (e.g., 100) and/or the second data processing system (e.g., 280). An assignment of the first data processing system (e.g., 100) and/or the second data processing system (e.g., 280) may be performed using a similarity map (e.g., 232) and/or at least one autonomy model.

According to the similarity map (e.g., 232), the first data processing system (e.g., 100) may have first attributes that may be similar to second attributes of the second data processing system (e.g., 280). As a result of the similarity between the first attributes and the second attributes, the at least one autonomy model may direct the first data processing system (e.g., 100) to collaborate with the second data processing system (e.g., 280). Therefore, using the first attributes of the first data processing system (e.g., 100) and the second attributes of the second data processing system (e.g., 280), each data processing system may (i) learn a less diverse approach to performing the low impact operation (e.g., 268), (ii) utilize similar resources to perform the low impact operation (e.g., 268), etc.

Using an example from the description of FIG. 2C, the first data processing system (e.g., 100) may perform spam detection of incoming e-mails for a business using certain keywords. However, an approach using basic keyword detection to filter e-mails may incorrectly flag and/or trash legitimate e-mails, which can have a measurable (e.g., a low, in this case) impact on commerce in a business that uses the first data processing system (e.g., 100).

To enable for more accurate spam detection of the e-mails, a second data processing system (e.g., 280) may be used. The second data processing system (e.g., 280), selected from the similarity map (e.g., 232), may be used by (i) receiving (e.g., 264) a flagged e-mail from the first data processing system (e.g., 100) and (ii) sending the flagged e-mail to a trained inference model to generate an output. The output may include a determination of whether the flagged e-mail is spam. The output may be sent (e.g., 266) from the second data processing system (e.g., 280) to the first data processing system (e.g., 100). Further, the second data processing system (e.g., 280) may use historical e-mails, already determined to be spam, to train and/or update the inference model.

Thus, via the first interaction illustrated in FIG. 2D, a system in accordance with an embodiment may collaborate, by two data processing systems (e.g., 100, 280, etc.), to perform the low impact operation (e.g., 268). Consequently, the data processing system (e.g., 100) may be more likely to be able to provide desired computer implemented services by leveraging combined computational resources of few data processing systems (e.g., 100, 280, etc.) with similar attributes.

Turning to FIG. 2E, a second interaction diagram in accordance with an embodiment is shown. The second interaction diagram may illustrate data used in and data processing performed in collaborating, by three data processing systems (e.g., 100, 280, 282 etc.), to perform a high impact operation (e.g., 270).

To perform the high impact operation (e.g., 270), operation performance process 272 may be performed. During operation performance process 272, at least one task of a high impact operation (e.g., 270) may be performed by a first data processing system (e.g., 100), a second data processing system (e.g., 280), and/or a third data processing system (e.g., 282). The at least one task may be included in the high impact operation (e.g., 270) because the at least one task may consume significant resources (e.g., memory, storage, etc.) of a system, have a substantial operation impact (e.g., 244) on a functionality of the system, etc.

Because the at least one task may consume significant resources (e.g., the memory, the storage, etc.), have the substantial operation impact (e.g., 244), etc., performance of the at least one task may be assigned to the first data processing system (e.g., 100), the second data processing system (e.g., 280), and/or the third data processing system (e.g., 282). An assignment of the first data processing system (e.g., 100), the second data processing system (e.g., 280), and/or the third data processing system (e.g., 282) may be performed using a similarity map (e.g., 232) and/or at least one autonomy model.

According to the similarity map (e.g., 232), the first data processing system (e.g., 100) may have first attributes that may be similar to second attributes of the second data processing system (e.g., 280). As a result of the similarity between the first attributes and the second attributes, the at least one autonomy model may direct the first data processing system (e.g., 100) to collaborate with the second data processing system (e.g., 280). Therefore, using the first attributes of the first data processing system (e.g., 100) and the second attributes of the second data processing system (e.g., 280), each data processing system may (i) learn a less diverse approach to performing the high impact operation (e.g., 270), (ii) utilize similar resources to perform the high impact operation (e.g., 270), etc.

Likewise, according to the similarity map (e.g., 232), the first data processing system (e.g., 100) may have the first attributes that may be dissimilar from third attributes of the third data processing system (e.g., 282). As a result of the dissimilarity between the first attributes and the third attributes, the at least one autonomy model may direct the first data processing system (e.g., 100) to also collaborate with the third data processing system (e.g., 282). Therefore, using the first attributes of the first data processing system (e.g., 100) and/or the third attributes of the third data processing system (e.g., 282), each data processing system may (i) learn a more diverse approach to performing the high impact operation (e.g., 270), (ii) utilize different resources to perform the high impact operation (e.g., 270), etc.

For example, the high impact operation (e.g., 270) may include fraud detection in at least one financial transaction. To perform the fraud detection, the first data processing system (e.g., 100), the second data processing system (e.g., 280), and/or the third data processing system (e.g., 282) may collaborate during operation performance process 272.

During operation performance process 272, the first data processing system (e.g., 100) may collect transaction data from at least one automated telling machines (ATM), at least one point-of-sale system, at least one online banking platform, etc. The first data processing system (e.g., 100) may send (e.g., 274) the transaction data to the second data processing system (e.g., 280). The second data transaction system (e.g., 280) may receive the transaction data and/or use rule-based algorithms to analyze the transaction data for at least one fraud pattern (e.g., multiple transactions in quick succession, large cash withdrawals, etc.) to generate flagged transaction data. The second data processing system (e.g., 280) may send (e.g., 276) the flagged transaction data to the first data processing system (e.g., 100).

Upon receiving the flagged transaction data, the first data processing system (e.g., 100) may send (e.g., 290) the flagged transaction data to the third data processing system (e.g., 282). The third data transaction system (e.g., 282) may receive the flagged transaction data and send the flagged transaction data to a trained machine learning model. The trained machine learning model may ingest the flagged transaction data and generate the output. The output may include at least one detailed risk score and/or at least one insight into the flagged transaction data. The third data transaction system (e.g., 282) may receive the output from the trained machine learning model and send (e.g., 292) the output to the first data processing system (e.g., 100). Upon receiving the output, the first data processing system (e.g., 100) may ingest the output and generate, based on the output, at least one action. The at least one action may include (i) altering at least one customer, (ii) blocking at least one fraudulent transaction, (iii) notifying at least one law enforcement agency, etc.

Thus, via the second interaction illustrated in FIG. 2E, a system in accordance with an embodiment may collaborating, by the three data processing systems (e.g., 100, 280, 282, etc.), to perform the high impact operation (e.g., 270). Consequently, the data processing system (e.g., 100) may be more likely to be able to provide desired computer implemented services by leveraging combined computational resources of more data processing systems (e.g., 100, 280, 282, etc.).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment comprising data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment comprising data processing systems in accordance with an embodiment is shown. The method may be performed, for example, by any of the components of the system of FIG. 1, and/or other components not shown therein.

At operation 300, a forthcoming operation may be obtained by a data processing system of the data processing systems. The forthcoming operation may be performable in at least two manners. The forthcoming operation may be obtained by (i) reading a configuration of the data processing system, (ii) ingesting an input by a user into the data processing system, (iii) following a scheduled event to perform the forthcoming operation, (iv) receiving a directive with the forthcoming operation in an application programming interface (API) call, etc.

At operation 302, an estimated impact level of the forthcoming operation on the deployment may be obtained by the data processing system. The estimate impact level may be obtained by (i) identifying at least one pattern and/or at least one outcome from at least one similar operation to the forthcoming operation that has been performed by the data processing system, (ii) simulating the forthcoming operation in a virtual environment to observe at least one effect of the forthcoming operation, (iii) performing a risk assessment of at least one task of the forthcoming operation to identify at least one risk (a system overload, a failure, potential for a security breach, etc.), (iv) obtaining an assessment of at least one effect of the forthcoming operation from the simulation, etc.

At operation 304, a level of autonomy may be identified by the data processing system for selection of a manner in which to perform the forthcoming operation based on the estimated impact level. The level of autonomy may be identified by authorizing, by an autonomy model, a measure of discretion to the data processing system in a performance of the forthcoming operation. The autonomy model may include software that can ingest the impact level of the forthcoming operation /d/ or determine the measure of the discretion. The measure of discretion may include a less autonomous (e.g., command-driven), a partially autonomous (e.g., consensus-based), a more autonomous (e.g., self-directed), etc. performance of the forthcoming operation by the data processing system (e.g., 100). With the measure of the discretion, the autonomy model may direct how the data processing system may collaborate with at least one other data processing system of the deployment.

At operation 306, at least one of the data processing system may be identified by the data processing system based on a similarity map and the level of autonomy. The at least one of the data processing systems may be identified by selecting, using the similarity map, the at least one other data processing system based on a measure of similarity between the data processing system and/or the at least one other data processing system. If the forthcoming operation may have a low impact level, the autonomy model may enable the data processing system to select the at least one other data processing system that is mostly similar to the data processing system. However, if the forthcoming operation may have a high impact level, the autonomy model may enable the data processing system to select the at least one other data processing system that is similar and/or dissimilar to the data processing system. Selecting the at least one other data processing system that is similar and/or dissimilar may enable the data processing system to, for example, (i) learn a diverse approach to performing the forthcoming operation, (ii) utilize different resources to perform the forthcoming operation, etc.

At operation 308, the manner in which to perform the forthcoming operation may be collaboratively selected by the data processing system with the at least one of the data processing systems. The manner in which to perform the forthcoming operation may be collaboratively selected by querying the at least one of the data processing systems regarding the manner to come to a collaborative decision regarding the manner in which to perform the forthcoming operation. The at least one of the data processing systems may be queried by transmitting at least one message between the data processing system and/or the at least one other data processing system. The at least one message may include (i) at least one task of the forthcoming operation to perform, (ii) at least one attribute of the data processing system and/or the at least one other data processing system, (iii) the estimate impact level of the forthcoming operation, (iv) a list of at least one resource needed to perform the at least one task by the data processing system and/or the at least one other data processing system, (v) a list that includes at least one manner of performing the at least one task of the forthcoming operation, etc.

At operation 310, the forthcoming operation may be performed, at least in part by the data processing system, the forthcoming operation in accordance with the selected manner of the forthcoming operation. The forthcoming operation may be performed by (i) decomposing the forthcoming operation into sub-operations and (ii) assigning at least a portion of the sub-operations for completion by others of the data processing systems. The forthcoming operation may be decomposed into sub-operations (e.g., the at least one task) by identifying the at least one task necessary to achieve a desired outcome by at least the data processing system. The at least the portion of the sub-operations (e.g., the at least one task) may be assigned for completion by assessing at least one capability of at least one of the data processing systems and/or matching the at least one capability with at least one requirement of the at least one task.

The method may end following operation 310.

Thus, via the method shown in FIG. 3, embodiments herein may likely improve a likelihood of managing operation of the deployment comprising data processing systems. By improving the likelihood of managing operation of the deployment comprising data processing systems, the data processing system may be more likely to provide desirable computer implemented services by, for example, using the similarity map to select the at least one of the data processing systems to collaborate with the data processing system, leveraging combined computational resources of the at least one of the data processing systems and/or the data processing system, etc.

Any of the components illustrated in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment comprising data processing systems, the method comprising:
obtaining, by a data processing system of the data processing system, a forthcoming operation, the forthcoming operation being performable in at least two manners;
obtaining, by the data processing system, an estimated impact level of the forthcoming operation on the deployment;
identifying, by the data processing system, a level of autonomy for selection of a manner in which to perform the forthcoming operation based on the estimated impact level;
identifying, by the data processing system, at least one of the data processing systems based on a similarity map and the level of the autonomy;
collaboratively selecting, by the data processing system with the at least one of the data processing systems, the manner in which to perform the forthcoming operation; and
performing, at least in part by the data processing system, the forthcoming operation in accordance with the selected manner of the forthcoming operation.

2. The method of claim 1, wherein the similarity map quantifies levels of similarity between the data processing systems.

3. The method of claim 2, wherein the levels of the similarity are based on, for the data processing system:
device information;
network information;
configuration information; and
workload information.

4. The method of claim 3, wherein the device information comprises:
a chassis identification;
a port identification;
a port description;
a system name;
a system description; and
capabilities of the data processing system.

5. The method of claim 3, wherein the network information comprises:
a virtual local area network of which the data processing system is a member;
a media access control address assigned to the data processing system; and
link information between the data processing system and others of the data processing systems.

6. The method of claim 3, wherein the configuration information comprises:
central processing unit specifications;
a memory capacity;
a storage capacity; and
software specifications.

7. The method of claim 3, wherein the workload information comprises:
an average central processing unit utilization;
a maximum central processing unit utilization;
a minimum central processing unit utilization;
an average memory utilization; and
application running schedules.

8. The method of claim 1, wherein performing the forthcoming operation comprises:
decomposing the forthcoming operation into sub-operations; and
assigning at least a portion of the sub-operations for completion by others of the data processing systems.

9. The method of claim 1, wherein collaboratively selecting the manner in which to perform the forthcoming operation comprises:
querying the at least one of the data processing systems regarding the manner to come to a collaborative decision regarding the manner in which to perform the forthcoming operation.

10. The method of claim 9, wherein the collaborative decision is a most common response to the querying of the at least one of the data processing systems.

11. The method of claim 1, wherein the level of the autonomy is identified using an autonomy model that vests more decision power in the data processing system as the level of impact is reduced and vests less decision power in the data processing system as the level of the impact is increased.

12. A non-transitory machine-readable medium having instructions stored therein, which when executed by a processor, cause the processor to perform operations for managing operation of a deployment comprising data processing systems, the operations comprising:
obtaining, by a data processing system of the data processing system, a forthcoming
operation, the forthcoming operation being performable in at least two manners;
obtaining, by the data processing system, an estimated impact level of the forthcoming operation on the deployment;
identifying, by the data processing system, a level of autonomy for selection of a manner in which to perform the forthcoming operation based on the estimated impact level;
identifying, by the data processing system, at least one of the data processing systems based on a similarity map and the level of the autonomy;
collaboratively selecting, by the data processing system with the at least one of the data processing systems, the manner in which to perform the forthcoming operation; and
performing, at least in part by the data processing system, the forthcoming operation in accordance with the selected manner of the forthcoming operation.

13. The non-transitory machine-readable medium of claim 12, wherein the similarity map quantifies levels of similarity between the data processing systems.

14. The non-transitory machine-readable medium of claim 13, wherein the levels of the similarity are based on, for the data processing system:
device information;
network information;
configuration information; and
workload information.

15. The non-transitory machine-readable medium of claim 14, wherein the device information comprises:
a chassis identification;
a port identification;
a port description;
a system name;
a system description; and
capabilities of the data processing system.

16. The non-transitory machine-readable medium of claim 14, wherein the network information comprises:
a virtual local area network of which the data processing system is a member;
a media access control address assigned to the data processing system; and
link information between the data processing system and others of the data processing systems.

17. A data processing system, comprising:
a processor; and
a memory coupled to the processor to store instructions, which when executed by the processor, cause the processor to perform operations managing operation of a deployment comprising data processing systems, the operations comprising:
obtaining, by the data processing system of the data processing system, a forthcoming operation, the forthcoming operation being performable in at least two manners;
obtaining, by the data processing system, an estimated impact level of the forthcoming operation on the deployment;
identifying, by the data processing system, a level of autonomy for selection of a manner in which to perform the forthcoming operation based on the estimated impact level;
identifying, by the data processing system, at least one of the data processing systems based on a similarity map and the level of the autonomy;
collaboratively selecting, by the data processing system with the at least one of the data processing systems, the manner in which to perform the forthcoming operation; and
performing, at least in part by the data processing system, the forthcoming operation in accordance with the selected manner of the forthcoming operation.

18. The data processing system of claim 17, wherein the similarity map quantifies levels of similarity between the data processing systems.

19. The data processing system of claim 18, wherein the levels of the similarity are based on, for the data processing system:
device information;
network information;
configuration information; and
workload information.

20. The data processing system of claim 19, wherein the device information comprises:
a chassis identification;
a port identification;
a port description;
a system name;
a system description; and
capabilities of the data processing system.
